(19) United States
(12) Patent Application Publication
(10) Pub. No.: US 2016/0047465 A1
(43) Pub. Date: Feb. 18, 2016

(54) METHOD OF CONTROLLING AUTOMATIC TRANSMISSION FOR REDUCING SYNCHRONIZATION SHOCK DURING UPSHIFT IN ACCELERATED STATE

(71) Applicant: Hyundai Motor Company, Seoul (KR)

(72) Inventors: Chan-Ho Lee, Seoul (KR); Dong-Ho Yang, Geoje-Si (KR); Young-Chul Kim, Seoul (KR); Sang-Joon Kim, Seoul (KR); Jung-Min Cha, Incheon (KR)

(73) Assignee: Hyundai Motor Company, Seoul (KR)

(21) Appl. No.: 14/555,342

(22) Filed: Nov. 26, 2014

(30) Foreign Application Priority Data
Aug. 18, 2014 (KR) 10-2014-0107270

(51) Int. Cl. F16H 61/04

(52) U.S. Cl. CPC F16H 61/0403; F16H 2061/0492

(57) ABSTRACT

A method of controlling an automatic transmission for reducing synchronization shock during an upshift in an accelerated state may include determining a shift progress rate, performing shift progress rate determination of determining whether the determined shift progress rate is higher than a certain value, performing PID control of a release element when the shift progress rate is determined to be higher than the certain value, performing release element-shared torque determination of determining whether a shared torque of the release element is higher than 0, and reflecting the PID control in the release element when the shared torque of the release element is determined to be higher than 0.

### CROSS-REFERENCE TO RELATED APPLICATIONS

The present application claims priority to Korean Patent Application No. 10-2014-0107270, filed on Aug. 18, 2014, which is incorporated herein by reference in its entirety.

### BACKGROUND OF THE INVENTION

1. Field of the Invention

Exemplary embodiments of the present invention relate to a method of controlling an automatic transmission for reducing synchronization shock during an upshift in an accelerated state; and, particularly, to a method of controlling an automatic transmission for reducing synchronization shock during an upshift in an accelerated state, capable of minimizing synchronization shock by a torque step generated after the end of an actual speed change range during an upshift in an accelerated state.

2. Description of Related Art

In general, a shift feeling during a power-on upshift (upshift generated in a case in which a vehicle is accelerated by pressing of an accelerator), which frequently occurs in an automatic transmission or a multistage transmission such as a DCT, is an important factor having an influence on merchantability.

However, the moment of rotational inertia is great in a hybrid system with a TMED (Transmission Mounted Electric Device) in which a motor is mounted to an input shaft of a transmission. Accordingly, since a vehicle with the hybrid system has a greater rotational inertia compared to a typical AT vehicle, shock is often brought during synchronization. Here, a TMED manner is a manner in which an electric motor is mounted to an automatic transmission. Driving modes of an HEV (Hybrid Electric Vehicle) to which the TMED manner is applied are largely divided into an HEV driving mode in which an engine and an electric motor are driven together and an EV driving mode in which the electric motor is driven. The driving modes are divided by on/off of the engine. The selection of the driving modes is a significant advantage for the hybrid vehicle in terms of fuel efficiency.

On the whole, a decrease of torque is generally requested in an actual speed change range in order to reduce a torque step generated after the end of the actual speed change range during control of a power-on upshift in the related art. That is, referring to FIG. 1, Nt is a turbine rotational speed, Ta is a shared torque of a coupling clutch, Tr is a shared torque of a release clutch, dNt is a total output shaft torque, Ti indicated by a dotted horizontal line is an output shaft torque at a previous gear, and Tj is an output shaft torque at a target gear.

FIG. 1 shows that the torque step is generated at the end of the actual speed change range. Since a shared torque in the actual speed change range is determined by the shared torque Ta of the coupling clutch, the shared torque Ta of the coupling clutch should be lowered. In this case, the actual speed change range may, however, be excessively longer since the turbine rotational speed Nt in the actual speed change range has a functional relation of the shared torque and input torque of the coupling clutch. Thus, for adapting the actual speed change range, the decrease of the engine torque is requested and PID control is used in the coupling element.

However, the decrease of the engine torque or the increase of the shared torque of the coupling element in the synchronization part is eventually present in only a direction in which the turbine is pulled downward. Accordingly, an only measure for smoothly controlling the end of the speed change range is to slightly reduce an amount of change of the turbine rotational speed by instantaneously lowering the shared torque of the coupling element. In this case, since the control measure is not a control measure of depending on repeated data about the amount and time for lowering the shared torque and following the target, the control measure may not be satisfied or vulnerable to disturbance. These problems may be obviously exhibited in a situation in which the characteristic of operating mechanism is poor as in a low-temperature hydraulic system or in a case of a hybrid system in which the moment of rotational inertia of a transmission input shaft is great.

In addition, the hybrid system with the TMED is difficult to obtain a good shift feeling since the response of the operating mechanism is slow when the performance of the operating mechanism is delayed in a specific situation as in the low-temperature hydraulic system and thus the synchronization is uneven.

That is, there is a limit to the method of reducing synchronization shock since the speed change range is controlled only by the coupling element together with the decrease of the torque as in the related art.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method of controlling an automatic transmission for reducing synchronization shock during an upshift in an accelerated state, capable of minimizing synchronization shock by a torque step generated after the end of an actual speed change range during an upshift in an accelerated state.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a method of controlling an automatic transmission for reducing synchronization shock during an upshift in an accelerated state includes calculating a shift progress rate, performing shift progress rate determination of determining whether the calculated shift progress rate is higher than a certain value, performing PID control of a release element when the shift progress rate is determined to be higher than the certain value, performing release element-shared torque determination of determining whether a shared torque of the release element is higher than 0, and reflecting the PID control in the release element when the shared torque of the release element is determined to be higher than 0.

The shift progress rate may be calculated by obtaining a difference value between a synchronized turbine rotational speed at a previous gear and a synchronized turbine rotational speed at a target gear and then dividing the difference value by a value of a rotational speed at which a turbine is actuated up to the synchronized turbine rotational speed at the target gear.

A release element control non-reflection may be performed when the shift progress rate is determined to be not higher than the certain value in the performing shift progress rate determination.

The release element control non-reflection may be performed when the shared torque of the release element is determined to be not higher than 0 in the performing release element-shared torque determination.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a graph illustrating a process of requesting a decrease of an engine torque and using PID control in a coupling element according to the related art.

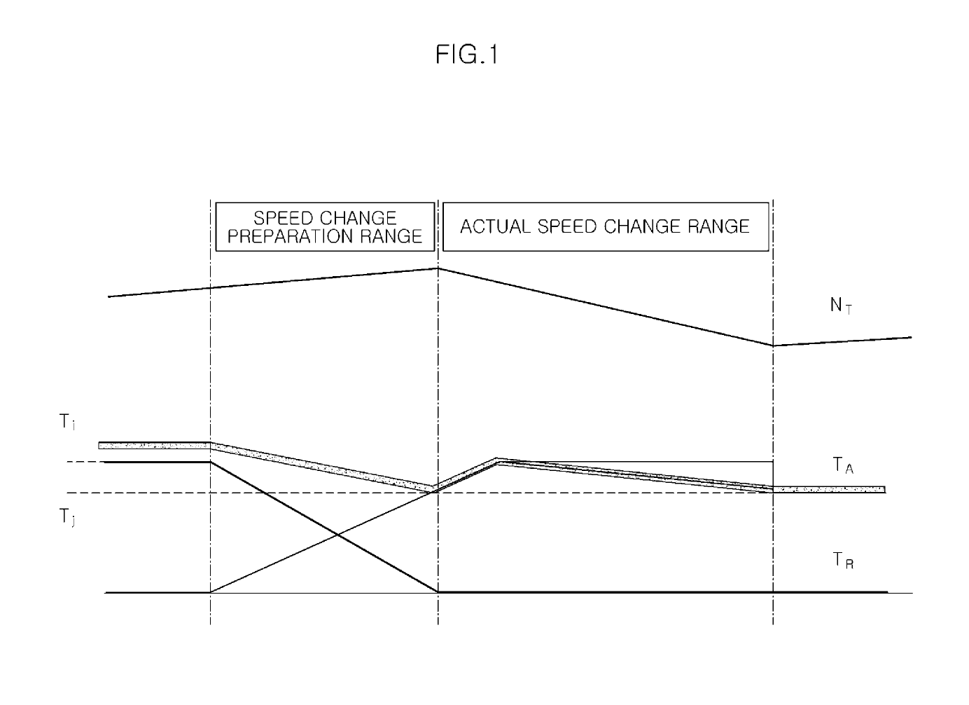

FIG. 2 is a flowchart illustrating a method of controlling an automatic transmission for reducing synchronization shock during an upshift in an accelerated state according to an exemplary embodiment of the present invention.

FIG. 3 is a graph illustrating a process to which the method of controlling an automatic transmission for reducing synchronization shock during an upshift in an accelerated state according to the exemplary embodiment of the present invention is applied.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several FIG. of the drawing.

### DESCRIPTION OF SPECIFIC EMBODIMENTS

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

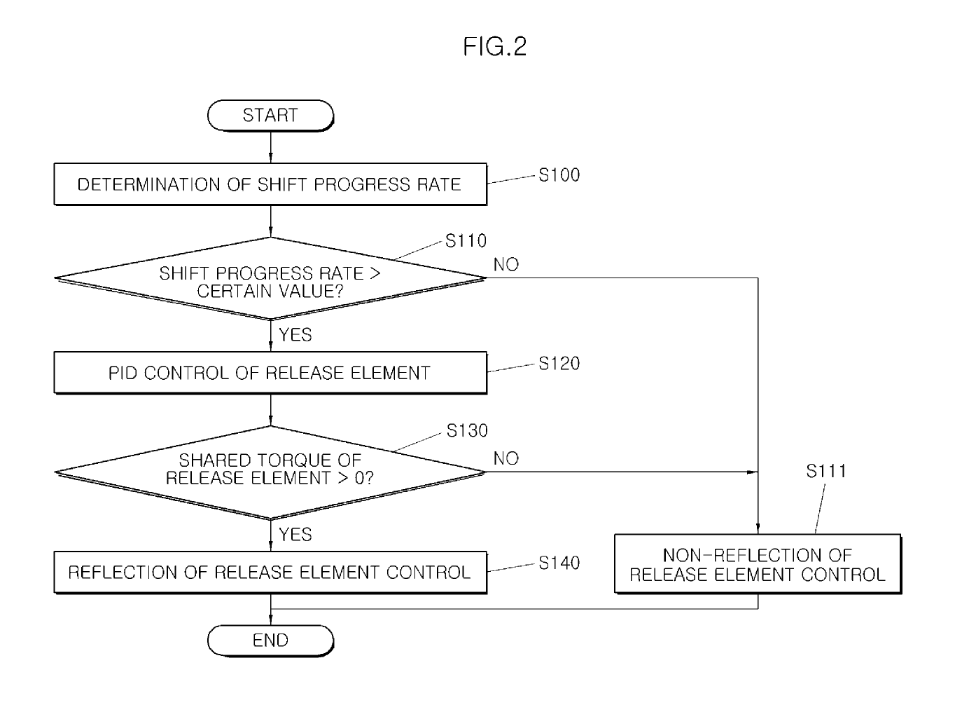

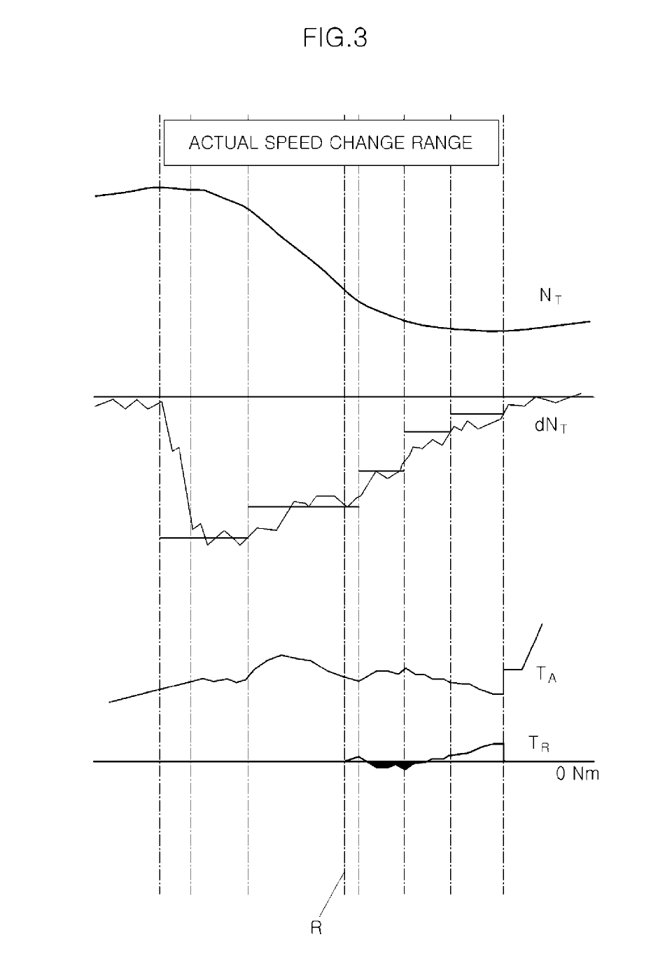

FIG. 2 is a flowchart illustrating a method of controlling an automatic transmission for reducing synchronization shock during an upshift in an accelerated state according to an exemplary embodiment of the present invention. FIG. 3 is a graph illustrating a process to which the method of controlling an automatic transmission for reducing synchronization shock during an upshift in an accelerated state according to the exemplary embodiment of the present invention is applied.

Hereinafter, the method of controlling an automatic transmission for reducing synchronization shock during an upshift in an accelerated state according to the exemplary embodiment of the present invention will be described with reference to FIGS. 2 and 3.

First, a shift progress rate calculation step S100 of calculating a shift progress rate is performed. Here, the shift progress rate is calculated by obtaining a difference value between a synchronized turbine rotational speed at a previous gear and a synchronized turbine rotational speed at a target gear and then dividing the difference value by a value of a rotational speed at which a turbine is actuated up to the synchronized turbine rotational speed at the target gear.

Subsequently, a shift progress rate determination step S110 of determining whether the calculated shift progress rate is higher than a certain value is performed. Since a main control element is a coupling element, an entry condition for use in a limited range such that a release element is not the main control element is defined in the shift progress rate determination step S110.

When the shift progress rate is determined to be higher than the certain value, a release element PID control step S120 of performing PID control of the release element is performed.

Subsequently, a release element-shared torque determination step S130 of determining whether a shared torque of the release element is higher than 0. When the shared torque of the release element is determined to be not higher than 0 in the release element-shared torque determination step S130, a release element control non-reflection step S111 is performed. Here, the release element operates oil pressure up to a position at which frictional force begins to be generated even when a command is not issued in an actual speed change range so as to be maintained close to a kiss point which is a point of time of slip control, thereby allowing the torque to be always shared. That is, as a result of the PID of the release element, the release element is maintained close to the kiss point when the shared torque is less than 0 and a release element control reflection step S140 of reflecting the PID control in the release element is performed only when the shared torque is higher than 0.

In accordance with a method of controlling an automatic transmission for reducing synchronization shock during an upshift in an accelerated state according to the exemplary embodiments of the present invention, it may be possible to reduce shock at the end of change of speed by controlling a release element in a multistage transmission having the great moment of rotational inertia or in a hydraulic system in which performance of operating mechanism is poor as in low temperature.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling an automatic transmission for reducing synchronization shock during an upshift in an accelerated state, comprising:
determining a shift progress rate;
performing shift progress rate determination of determining whether the determined shift progress rate is higher than a certain value;
performing PID control of a release element when the shift progress rate is determined to be higher than the certain value;
performing release element-shared torque determination of determining whether a shared torque of the release element is higher than 0; and
reflecting the PID control in the release element when the shared torque of the release element is determined to be higher than 0.

2. The method of claim 1, wherein the shift progress rate is determined by obtaining a difference value between a synchronized turbine rotational speed at a previous gear and a synchronized turbine rotational speed at a target gear and then dividing the difference value by a value of a rotational speed at which a turbine is actuated up to the synchronized turbine rotational speed at the target gear.

3. The method of claim 2, wherein a release element control non-reflection is performed when the shift progress rate is determined to be not higher than the certain value in the performing shift progress rate determination.

4. The method of claim 3, wherein the release element control non-reflection is performed when the shared torque of the release element is determined to be not higher than 0 in the performing release element-shared torque determination.
